(19) United States
(12) Patent Application Publication
(10) Pub. No.: US 2009/0320031 A1
(43) Pub. Date: Dec. 24, 2009

(54) Power state-aware thread scheduling mechanism

(76) Inventor: Justin J. Song, Olympia, WA (US)

Correspondence Address: INTEL CORPORATION;c/o CPA Global, P.O. BOX 52050, MINNEAPOLIS, MN, 55402, US

(21) Appl. No.: 12/214,523

(22) Filed: Jun. 19, 2008

(51) Int. Cl. G06F 9/46

(52) U.S. Cl. 718/102

(57) ABSTRACT

A system filter is maintained to track which single-thread cores [or which multi-threaded logical CPUs] are in a low-latency power state. For at least one embodiment, low-latency power states include an active C0 state and a low-latency C1 idle state. The system filter is used to filter out any cores/thread contexts in a high-latency state during task scheduling. This may be accomplished by filtering the OS-provided task affinity mask by the system filter. As a result, tasks are scheduled only on available cores/logical CPUs that are in an active or low-latency idle state. Other embodiments are described and claimed.

### BACKGROUND

Power and thermal management are becoming more challenging than ever before in all segments of computer-based systems. While in the server domain it is the cost of electricity that drives the need for low power systems, in mobile systems battery life and thermal limitations make these issues relevant. Managing a computer-based system for maximum performance at minimum power consumption may be accomplished by reducing power to all or part of the computing system when inactive or otherwise not needed.

One power management standard for computers is the Advanced Configuration and Power Interface (ACPI) standard, e.g., Rev. 3.0b, published Oct. 10, 2006, which defines an interface that allows the operating system (OS) to control hardware elements. Many modern operating systems use the ACPI standard to perform power and thermal management for computing systems. An ACPI implementation allows a core to be in different power-saving states (also termed low power or idle states) generally referred to as so-called C1 to Cn states.

When the core is active, it runs at a so-called C0 state, but when the core is idle, the OS tries to maintain a balance between the amount of power it can save and the overhead of entering and exiting to/from a given state. Thus, C1 represents the low power state that has the least power savings but can be switched on and off almost immediately (thus referred to as a “shallow low power state”), while deep low power states (e.g., C3) represent a power state where the static power consumption may be negligible, depending on silicon implementation, but the time to enter into this state and respond to activity (i.e., back to active C0) is relatively long. Note that different processors may include differing numbers of core C-states, each mapping to one ACPI C-state. That is, multiple core C-states can map to the same ACPI C-state.

Current OS C-state policy may not provide the most efficient performance results because it does not take into account the costs of entering and exiting the deeper power states. That is, current OS C-state policy may not consider activities of other cores in the same package. Since workloads are often multi-tasked, if one core is in a deep sleep state and is invoked to service a task, the other cores that are already in a shallower C-state may have been able to perform the task more efficiently. Current approaches may thus fail to extract additional power and performance savings.

### BRIEF DESCRIPTION OF THE DRAWINGS

FIG. 1 is a block diagram illustrating at least one embodiment of a system to perform disclosed techniques.

FIG. 2 is a block diagram representing alternative sample embodiments of scheduling examples.

FIG. 3 is a data- and control-flow diagram illustrating at least one embodiment of a method for taking C-state into account during task scheduling.

FIG. 4 is a data- and control-flow diagram illustrating at least one embodiment of a methods for maintaining a system C-state filter based on entry into and exit out of idle C-states.

FIG. 5 is a block diagram of a system in accordance with at least one embodiment of the present invention.

FIG. 6 is a block diagram of a system in accordance with at least one other embodiment of the present invention.

FIG. 7 is a block diagram of a system in accordance with at least one other embodiment of the present invention.

### DETAILED DESCRIPTION

Embodiments can accurately and in real time select a most appropriate core of a processor package to perform a task, taking current C-states into account in order to enhance power savings without corresponding performance degradation. More specifically, a system-wide filter may be provided to indicate which cores are available at shallow C-states to perform tasks. For at least one embodiment, the new system filter may be used in conjunction with exsisting OS mechanisms in order to achieve scheduling of tasks on those cores for which the least cost (in terms of power and/or time) will be incurred. Note that the processor core C-states described herein are for an example processor such as those based on IA-32 architecture and IA-64 architecture, available from Intel Corporation, Santa Clara, Calif., although embodiments can equally be used with other processors. Shown in Table 1 below is an example designation of core C-states available in one embodiment, and Table 2 maps these core C-states to the corresponding ACPI states. However, it is to be understood that the scope of the present invention is not limited in this regard.

Available cores for incoming tasks are marked in a system C-state filter in order to try to maximize power savings while generating as little negative performance effect as possible. A core is marked as “available” in the system C-state filter if it is in an active state (e.g., C0) or is in a shallow low power state (e.g., C1). A core is marked in the system C-state filter as “unavailable” if it is in a deep low power state. By taking this system C-state filter into account when performing the scheduling of tasks, the operating system may optimize performance by avoiding the latency associated with exit from a deep power state and may also optimize power savings by allowing cores in the deep low power states to remain so.

Embodiments may be deployed in conjunction with OS C-state and scheduling policy, or may be deployed in platform firmware with an interface to OS C-state policy and scheduling mechanisms.

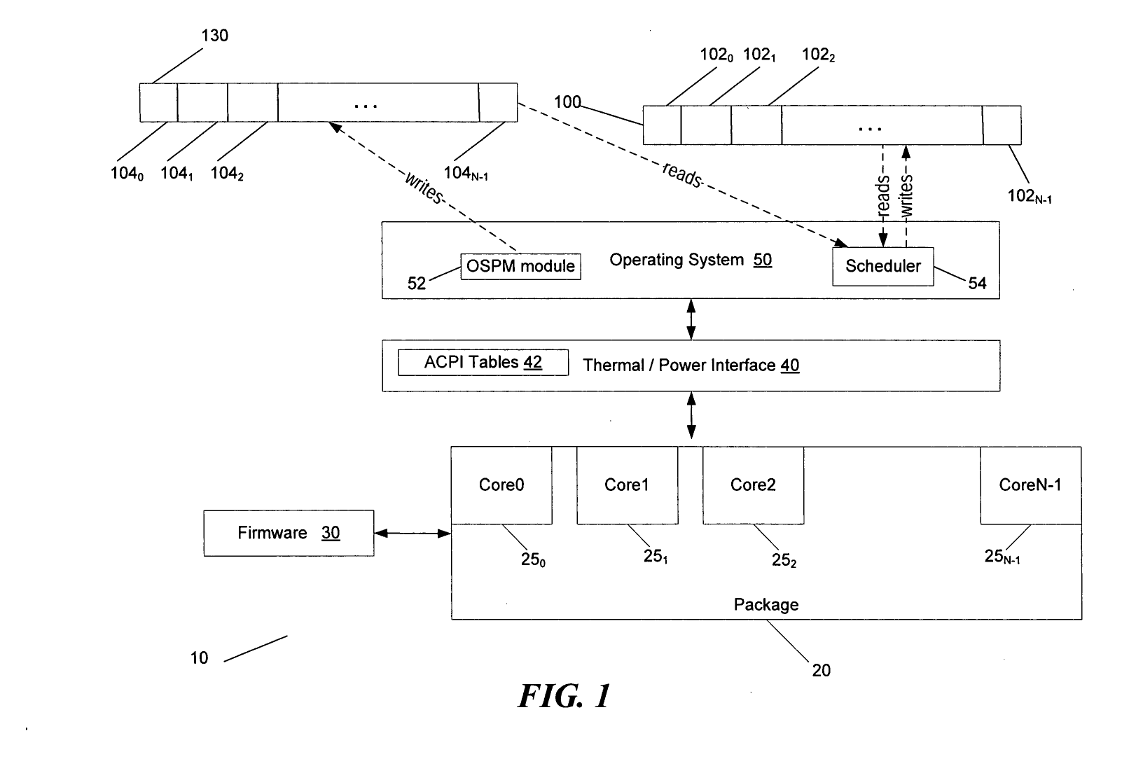

Referring now to FIG. 1, shown is a block diagram of a system 10 that employs a scheduling mechanism to take processor state into account in accordance with one embodiment of the present invention. As shown in FIG. 1, system 10 includes a processor package 20 having a plurality of processor cores 25₀-25ₙ₋₁ (generically core 25). The number of cores may vary in different implementations, from dual-core packages to many-core packages including potentially large numbers of cores. Each core 25 may include various logic and control structures to perform operations on data responsive to instructions. Although only one package 20 is illustrated, the described methods and mechanisms may be employed by computing systems that include multiple packages as well.

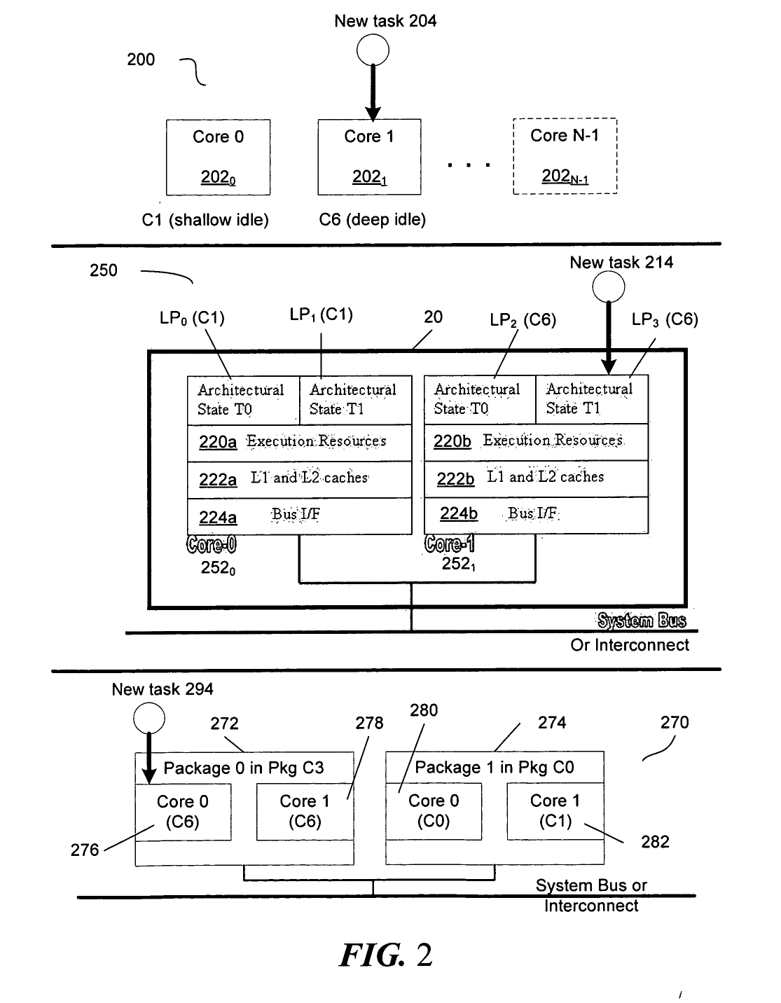

For at least one embodiment, one or more of the cores may support multiple hardware thread contexts per core. (See, e.g., system 250 of FIG. 2, in which each core 25 supports two hardware threads per core.) Such embodiment should not be taken to be limiting, in that one of skill in the art will understand that each core may support more than two hardware thread contexts. The terms “logical CPU” and “hardware thread context” are used interchangeably herein.

FIG. 1 illustrates that a computing system may include additional elements. For example, in addition to the package hardware 20 the system 10 may also include a firmware layer 30, which may include a BIOS (Basic Input-Output System). The computing system 10 may also include a thermal and power interface 40. For at least one embodiment, the thermal and power interface 40 is a hardware/software interface such as that defined by the Advanced Configuration and Power Interface (ACPI) standard, e.g., Rev. 3.0b, published Oct. 10, 2006, mentioned above. The ACPI specification describes platform registers, ACPI tables, e.g., 42, and the operation of an ACPI BIOS. FIG. 1 shows these collective ACPI components logically as a layer between the package hardware 20 and firmware 30, on the one hand, and an operating system (“OS”) 50 on the other.

FIG. 1 further illustrates that operating system 50 may be configured to interact with the thermal and power interface 40 in order to direct power management for the package 20. Accordingly, FIG. 1 illustrates a system 10 capable of using an ACPI interface 40 to perform Operating System-directed configuration and Power Management (OSPM).

FIG. 1 illustrates that the operating system 50 includes a module 52 that performs the OSPM function. The OSPM module 52 includes logic (software, firmware, hardware, or combination) to select the ACPI state for the hardware contexts of the cores 25. For at least one embodiment, the OSPM module 52 is system code in the OS kernel. Thus, for at least one embodiment the OSPM module 52 manages the ACPI state selection for the [single-threaded] cores or [multi-threaded] thread contexts/logical CPUs of the system 10.

The OS 50 may also include an APCI driver (not shown) that establishes the link between the operating system or application and the PC hardware. The driver may enable calls for certain ACPI-BIOS functions, access to the ACPI registers and the reading of the ACPI tables 42.

For at least embodiment, the OS 50 interacts with an affinity mask 100. The affinity mask 100 is used to effect “CPU affinity”, which is the ability to bind one or more processes to one or more processors. A user may invoke a system call to modify the bits of the affinity mask 100. By setting the appropriate bits in the affinity mask 100, the user may indicate a desire to “always run this process on processor one” or “run these processes on all processors but processor zero”, etc. In other words, the affinity mask 100 is a mechanism that allows developers to explicitly programmatically specify which processor (or set of processors) a given process may run on. Even if a programmer does not avail herself of this mechanism, the OS 50 may set a default value for a task's affinity mask 100.

For at least one embodiment, the task affinity mask 100 may be implemented as a bitmask. The bitmask 100 may include a series of n bits, one for each of n hardware threads in the system. For example, a system with four single-threaded physical CPUs includes four bits in the bit mask 100. If those CPUs are hyperthread-enabled, with two SMT (simultaneous multithreading) hardware thread contexts per core, then tasks for the system would have an eight-bit bitmask 100. If a given bit is set for a given task, that task may run on the associated CPU/thread context. Therefore, if a task is allowed to run on any CPU/thread context and allowed to migrate across processors/thread contexts as needed, the bitmask would be entirely 1 s. This is, in fact, the default state for tasks under some operating systems.

Accordingly, each task may have an instance of the affinity bitmask 100 associated with it. As is stated above, the bitmask 100 includes a bit position 102 for each hardware thread in the system 10. A value of 1B‘1’ in a particular bit position 102 indicates that the task is allowed to be scheduled on the associated processor/thread context. If, as is described above, OS scheduler 54 assigns an all-one affinity mask to a task, the task can run on any CPU (or hardware thread context) present in the system. For example, on quad-core system where each core is two-way SMT-threaded, the default affinity bitmap could be set by the scheduler 54 as:

Default affinity mask=1B‘11111111’, where the first bit is for logical CPU 0 and the last bit for logical CPU 7.

Once spawned, the task's affinity mask doesn't change, unless the OS kernel or application itself changes the affinity explicitly (for example, on Linux use OS kernel API: sched_setaffinity). For example, an application may set its preferred affinity to be Affinity mask=1B‘10001011’, which means the task is only allowed on logical CPUs 0, 4, 6, and 7.

FIG. 1 illustrates an additional system C-state filter 130 that is maintained in order to provide guidance to the OS scheduler 54 so that C-state may be taken into account in order to make efficient scheduling decisions. The system C-state filter 130 may be maintained in a memory location. For at least one alternative embodiment, the system C-state filter 130 may be maintained in a hardware register. Regardless of where they are stored, the system C-state filter 130 contents are managed and updated, for at least one embodiment, by the OSPM module 52. As used herein, the term “maintain” includes the updating of information stored in the filter 130. As with the affinity mask 100, the system C-state filter 130 may be implemented as a bitmask, with each bit position 104 corresponding to a particular logical CPU or core. For at least one alternative embodiment, the system C-state filter may be implemented as separate indicators for each thread context or core.

For purposes of example, Table 1 below shows core C-states and their descriptions, along with the estimated power consumption and exit latencies for these states, with reference to an example processor having a thermal design power (TDP) of 130 watts (W). Of course it is to be understood that this is an example only, and that embodiments are not limited in this regard. Table 1 also shows package C-states and their descriptions, estimated exit latency, and estimated power consumption.

TABLE 1

| | | | | Estimated |
|---|---|---|---|---|
| | | Estimated Exit | | power |
| | Description | Latency | | consumption |
| Core C0 | All core logics active | N/A | | 26.7 W |
| Core C1 | Core clockgated | 2 | μs | 1.5 W |
| Core C3 | Core multi-level cache | 10-20 | μs | 1 W |
| | (MLC) flushed and | | | |
| | invalidated | | | |
| Core C6 | Core powergated | 20-40 | μs | 0.04 W |
| Core C7 | Core powergated and | 20-40 | μs | 0.04 W |
| | signals “package (pkg) last | | | |
| | level cache (LLC) OK-to- | | | |
| | shrink” | | | |
| Pkg C0 | All uncore and core logics | N/A | | 130 W |
| | active | | | |
| Pkg C1 | All cores inactive, pkg | 2-5 | μs | 28 W |
| | clockgated | | | |
| Pkg C3 | Pkg C1 + all external links to | ~50 | μs | 18 W |
| | long-latency idle states + put | | | |
| | memory in short-latency | | | |
| | inactive state | | | |
| Pkg C6 | Pkg C3 + reduced voltage for | ~80 | μs | 10 W |
| | powerplane (only very low | | | |
| | retention voltage remains) + | | | |
| | put memory in long-latency | | | |
| | inactive state | | | |
| Pkg C7 | Pkg C6 + LLC shrunk | ~100 | μs | 5 W |

Table 1 illustrates that C0 and C1 are relatively low-latency power states, while the deep C-states are high-latency states.

Table 2 shows an example mapping of core C-states of an example processor to the ACPI C-states. Again it is noted that this mapping is for example only and that embodiments are not limited in this regard.

TABLE 2

Core C0→ACPI C0
Core C1→ACPI C1
Core C3→ACPI C1 or C2
Core C6→ACPI C2 or C3
Core C7→ACPI C3

It is to be noted that package C-states are not supported by ACPI; therefore, no ACPI mappings are provided in Table 2 for package C-states listed above in Table 1.

We now turn to FIG. 2 for a brief discussion to illustrate the scheduling inefficiencies that may occur when the OS scheduler 54 (FIG. 1) fails to take into account the power and exit latency information set forth in Table 1. FIG. 2 illustrates three sample embodiments of systems. A first system 200 includes two or more single-threaded cores, 202₀ through 202_{N-1}. Optional additional cores are indicated in FIG. 2 with broken lines and ellipses.

If a task is spawned or re-scheduled onto an core that is in a deep C-state rather than on a core that is in an active or shallow idle C-state, both power and performance inefficiencies will be incurred. For purposes of illustration, FIG. 2 illustrates that core 202₀ is in C1 core state (shallow idle), but that core 202₁ is in C6 core state (deep idle).

If, as is illustrated in FIG. 2, a new task 204 is scheduled on the core 202₁ that is in the C6 state rather than on the core 202₁ that is in the shallow C1 state, the following results will occur, according the estimated values in Table 1. A first result is that performance is negatively affected. The task 204 must wait unnecessarily long to be performed. This is due to the fact that deep C-states are high-latency idle states while C1 is a low-latency idle state. The C6 state's relatively longer exit latency time to enter the active C0 state is 20-40 μseconds, compared with the C1 state's 2 μsecond latency to enter into the C0 state.

A second result of the inefficient scheduling example illustrated for system 200 of FIG. 2 is one of power consumption. Table 1 illustrates that power consumption for the core 202, that is in the C6 state is 0.4 watts, whereas the core 202₀ that is in C1 core state is already consuming more than 3 times more power (1.5 watts). By scheduling the task 204 on core 202₁, total power consumption for the two cores (202₀, 202₁) is raised to 28.2 watts. In contrast, by scheduling the task 204 on the core 202₀ that is in the shallow C1 core state, total power consumption for the two cores would be raised to only 27.1 watts.

Similar considerations apply to the second example system 250 illustrated in FIG. 2. A second system 250 includes a package 20 that includes two cores, 252₀ and 252₁. Of course, while the package 20 illustrates only two cores, this simplification is for ease of illustration only. One of skill in the art will recognize that a package 20 may include any number of cores without departing from the scope of the embodiments described and claimed herein.

The cores 252₀ and 252₁ of the second embodiment 250 are multi-threaded cores. That is, FIG. 2 illustrates that each core 252 of the second embodiment 250 is a dual-threaded SMT core, where each core 252 maintains a separate architectural state (T₀, T₁) for each of two hardware thread contexts LP, but where certain execution resources 220 are shared by the two hardware thread contexts. For such embodiment, each hardware thread context LP (or “logical CPU”) may have a separate C-state. Accordingly, each hardware thread context LP has a corresponding bit in the affinity mask (e.g., 100 of FIG. 1) and has a corresponding bit in the system C-state filter (e.g., 130 of FIG. 1).

If a task is spawned or re-scheduled onto an idle hardware thread that is in a deep C-state rather than on a core that is in a shallow idle C-state, both power and performance inefficiencies will be incurred. For purposes of example, assume that each hardware thread (LP₀, LP₁) of Core 0, 252₀, is in a shallow idle C-state (e.g., C1). Assume that each hardware thread (LP₂, LP₃) of core 1, 252₁, is in a deep C-state (e.g., C6). If an incoming task 214 is scheduled on LP2 or LP3 instead of LP0 or LP 1, then power and performance inefficiencies will be experienced as explained above in connection with the first example 200 of FIG. 2.

The third example system 270 of FIG. 2 illustrates that these power and performance inefficiencies may also occur at the package level. Example system 270 is a multi-package platform that includes two or more packages 272, 274. Although only two packages 272, 274 are illustrated in FIG. 2, one of skill in the art will recognize that such illustration should not be taken to be limiting, and that the performance and power advantages of the mechanisms described and claimed herein may be realized for platforms that include a larger number of packages.

FIG. 2 further illustrates that each package 272, 274 includes two cores (276, 278, 280, 282). Again, such illustration should not be taken to be limiting. Other embodiment may include more or fewer cores.

For purposes of illustration, FIG. 2 assumes that the cores (276, 278) for Package 0, 272, are both in a deep lower-power state, C6. Thus, the entire package 272 is in an idle state (Pkg C1). In contrast, Package 1, 274, is in active C0 state. However, not all cores of Package 1, 274, are currently executing instructions. Instead, although Core 0, 280, is in the active C0 state, the other core (Core 1, 282), is in a shallow C1 idle core state. That is, even though Package 1, 274, is in an active Pkg C0 state, there is an idle core 282 in the package 274.

Table 1 illustrates that the power required to maintain a package in the Pkg C0 active state is 130 watts. Table 1 further illustrates that the power required to maintain a package in the Pkg C3 idle state is 18 watts. FIG. 2 illustrates that, for the third example system 270, the OS scheduler (see, e.g., 54 of FIG. 1) has spawned or re-scheduled a task 294 on a core 276 of an idle package 272 even though at least one core 282 of the busy package 274 is idle and available to do work. For the example 270 shown in FIG. 2, the idle package 272 is required to leave an efficient power state (that requires only 18 watts) to enter a much more power hungry Pkg C0 state, which requires 130 watts of power. This is highly inefficient, in that this 132-watt differential could be reduced if, instead, Core 1 282 of the active package 274 were to perform the task 294. In the latter case, Core 1 282 would increase power consumption from 1.5 watts to 26.7 watts, which yields only a 25.2-watt differential (vs. 132 watts).

The third example 270 also illustrates a performance inefficiency as well. It would take Core 1, 282, of the active package 274 only two micro-seconds to transition from the C1 to C0 state. In contrast, according to the estimations in Table 1, Package 0, 272, will require around 50 microseconds to transition from Pkg C3 state to Pkg C0 state.

Accordingly, the example embodiments 200, 250, 270 in FIG. 2 illustrate that spawning or re-scheduling a task onto an idle core or hardware thread that is in a deep C-state rather than spawning or re-scheduling it onto a different idle core or hardware thread that is in an active or shallow idle C-state can result in a performance drop due to the longer latency time to exit a deep C-state into active C0 state.

In addition, the examples in FIG. 2 further illustrate power inefficiencies. That is, waking up a core or hardware thread from a deep core C-state (whose power is relatively low), or waking up a package from a deep package C-state (whose power is relatively low), to execute a task while leaving another idle core, hardware thread, or package (with an idle core) in a shallow C-state (whose power consumption is relatively high), results in higher power consumption.

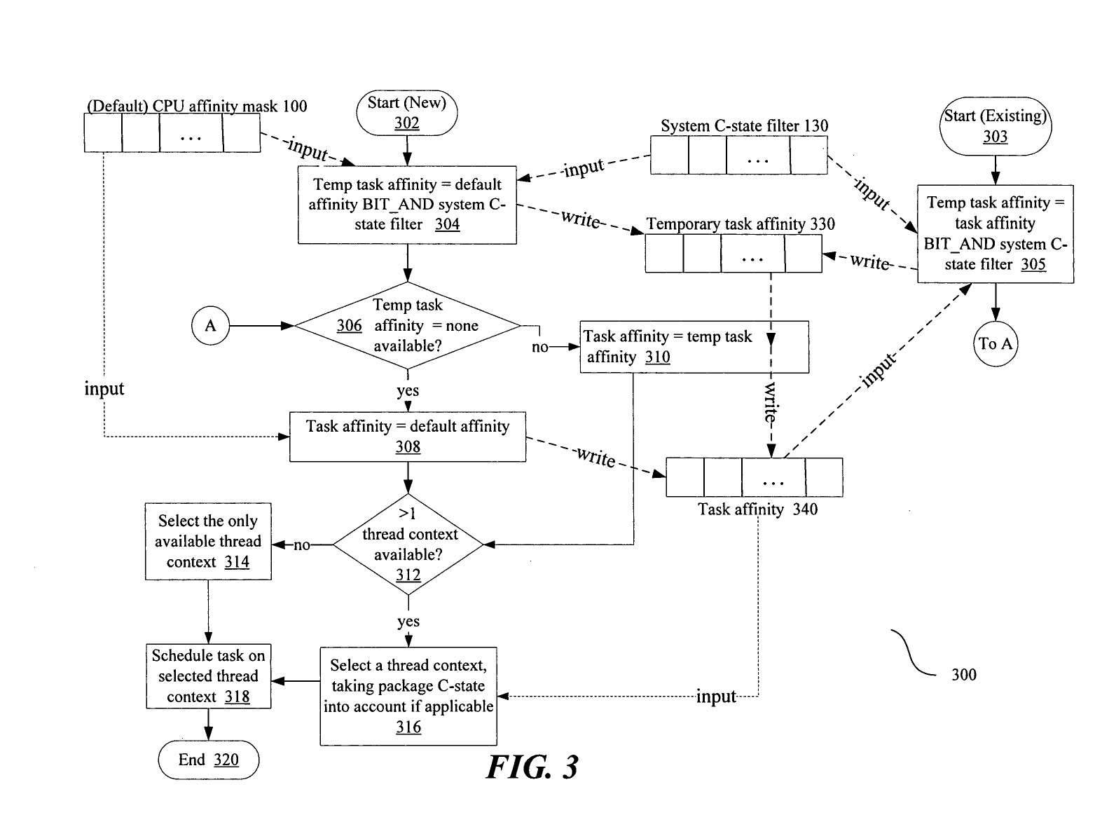

FIG. 3 is a data- and control flow diagram illustrating at least one embodiment of a method 300 for taking package and/or core C-state into account during task scheduling. For at least one embodiment, the method 300 illustrated in FIG. 3 may be performed by an OS scheduler module (see, e.g., 54 of FIG. 1). The method 300 utilizes a system C-state filter 130, in conjunction with a task's CPU affinity mask 100, to determine a thread context on which to schedule the task.

FIG. 3 illustrates that the method 300 begins at start block 302 for a newly-spawned task and begins at block 303 for an existing task. Start block 302 may be triggered by spawning of a new task that needs to be scheduled. Alternatively, the start block 303 may be triggered by re-activation of an existing task or by notification that an existing task needs to be re-scheduled.

At least one embodiment of the method 300 assumes that a default CPU affinity is established for the task in a known manner. For at least one embodiment, the default CPU affinity for the incoming task is set by the operating system (see, e.g., 50 of FIG. 1) in an instance of the CPU affinity mask 100 that is associated with the task.

From start bock 302, processing proceeds to block 304. From start block 303, processing proceeds to block 305. At blocks 304 and 305, a temporary affinity value is established for the incoming task. Both blocks 304, 305 utilize the system C-state filter 130 to calculate the temporary task affinity.

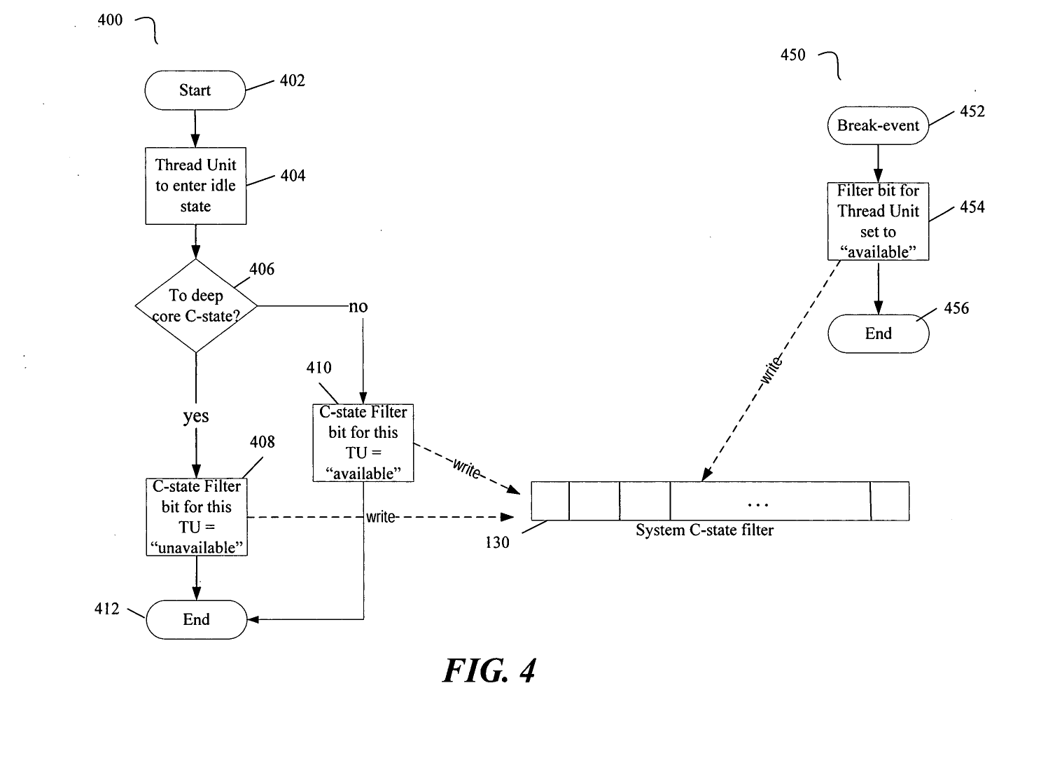

As is explained below in further detail in connection with FIG. 4, the system-wide C-state may be indicated in the system C-state filter 130. The update and management activity (see, e.g., FIG. 4, discussed below) of the system C-state filter 130 may be performed, for at least one embodiment, by the operating system kernel's OSPM module (e.g., 52 of FIG. 1). Each bit (see, e.g., 104 of FIG. 1) of the system C-state filter 130 represents a logical CPU (also referred to interchangeably herein as a “hardware thread context” and/or “thread unit”). A logic-high value of 1B“1” represents that the CPU is “available”. That is, a 1B“1” value means that the corresponding logical CPU is active (in C0) or in a “shallow”, or short-latency, C-state such as C1. A logic-low value of 1B“0” for a bit of the system C-state filter 130 represents that the associated logical CPU is “unavailable”, which means that the corresponding logical CPU is in a deep C-state, such as C3, C6, C7, etc. The discussion below of FIG. 4 indicates that, whenever a logical CPU enters a deep C-state, the OSPM (e.g., 52 of FIG. 1) clears the corresponding bit; whenever a logical CPU goes back to C0 or enters C1, the OSPM (e.g., 52 of FIG. 2) sets the corresponding bit.

One of skill in the art will recognize that the values of 1B“0” and 1B‘1” are used herein for illustrative purposes only, and that such illustrative discussion should not be taken to be limiting. Depending on the system hardware and other programming considerations, different logic-high and logic-low values may be used to represent “available” and “unavailable” status. In addition, it is not necessarily required that the “available” and “unavailable” status of each logical CPU be a one-bit value. For example, in alternative embodiments, the system C-state filter 130 may include multiple bit-positions for the status of each logical CPU. Also, for example, other alternative embodiments may, rather than a single bit-mask, maintain the available/unavailable status of each logical CPU in a separate indicator.

For an existing task, it is presumed that a prior iteration of method 300 was performed for the task when it was newly-spawned. In contrast, it is assumed that no prior iteration of the method 300 has been performed for a newly-spawned task. As a result of the presumption that an existing task has already had its task affinity calculated previously, the temporary affinity value for new and existing tasks are performed slightly differently at bocks 304 and 305.

At block 304 the default CPU affinity mask 100 is consulted to determine the OS-provided availability status for each logical CPU for the current task. The system C-state filter 130 is also consulted to determine whether the default OS-provided availability of a logical CPU should be overridden by the value for that logical CPU in the system C-state filter 130. In this manner, the system C-state filter 130 acts as a mask to filter out any CPU that is indicated as available in the task affinity filter 100, but that is in a deep C-state.

Accordingly, at block 304 it is determined that a logical CPU is available for scheduling of the current task only if the logical CPU is indicated as available in the task's CPU affinity filter 100 AND the logical CPU is indicated as available in the system C-state filter 130. For an embodiment where the system C-state affinity filter 130 is maintained as a single bit-mask, the processing at block 304 is accomplished via a bit-wise logical AND operation. That is, when the OS scheduler is to schedule a newly-spawned or existing task/thread, it creates at block 304 a temporary task affinity value 330.

The temporary task affinity 330 is therefore created at block 304 with input from the default CPU affinity mask 100 and with input from the system C-state filter 130. The results of the bit-wise AND operation may be stored in a memory location referred to in FIG. 3 as a temporary task affinity 330. Processing then proceeds from block 304 to block 306.

At block 305, the temporary task affinity value 330 is generated for an existing task. That is, it is assumed that an existing task has previously been through at least one iteration of the method 300 when it was originally spawned. As such, it is assumed that the processing of blocks 304 through 320 have previously been performed for the existing task.

During the previous iteration, a task affinity was determined at block 308 or 310 (depending on the determination at block 306). If the task, after it was spawned and the task affinity determined at a previous iteration of block 308 or 310, includes an explicit software instruction to modify its affinity, such modification would have been made to the task affinity value 340 for the task. Thus, at block 305 when that existing task goes through a current iteration of the method 300, the previously-set task affinity value 340 is used as an input to block 305, such that any CPU affinity settings explicitly set by the user program for the current task are preserved in the temporary task affinity 330 for the task during the current iteration of the method 300.

Accordingly, FIG. 3 illustrates that, at block 305 the temporary task affinity 330 is determined for the current task by filtering the existing task affinity mask 340 for the task by the current system CPU C-state filter 100. For at least one embodiment, this is accomplished via a bit-wise AND operation of the previously-determined task affinity mask 340 for the task with the current system C-state filter 100. The results of this operation are stored in the temporary task affinity 330 for the task. Processing then proceeds from block 305 to block 306.

At block 306, the resulting value of the temporary task affinity 330 is examined. If it is determined at block 306 that the contents of the temporary task affinity 330 indicate that NO thread context is available, then the temporary task affinity 330 is disregarded and processing proceeds to block 308. Otherwise, if the temporary task affinity 330 indicates that at least one thread context is available for the task, then processing proceeds to block 310.

If block 308 is reached, that means that it has been determined that the logical AND operation of the current task's default CPU affinity mask 100 and the system C-state filter 130 was all zeros. (It will be understood that any appropriate value may be used to indicate non-availability of a thread context). That is, the AND operation of block 304 or 305 indicates that all thread contexts are unavailable because any thread context available under the default mask provided by the operating system in bit mask 100 is also indicated in the C-state affinity mask 130 as being in a deep idle C-state. Thus, it will not be possible to effect C-state aware scheduling efficiencies for the current task. As such, the system C-state affinity filter 130 contents should be disregarded and the default CPU affinity mask 100 should be instead used for further scheduling processing. Thus, at block 308 the task affinity value 340 for the task is set to reflect the contents of the default CPU affinity mask 100 for the task.

If, on the other hand, processing arrives at block 310, then at least one thread context is indicated in the temporary task affinity 330 as being available for the task. In such case, the task affinity value 340 for the task is set to reflect the contents of the temporary task affinity 330.

Processing proceeds to block 312 from both of block 308 and block 310. At decision block 312, it is determined whether the task affinity 340 indicates more than one available thread context for the task. If not, then processing proceeds to block 314. Otherwise, processing proceeds to block 316.

At block 314, the only available thread context, as indicated in the task affinity value 340, is selected.

At block 316, one of the multiple available thread contexts is selected. For a single package embodiment that includes multiple cores (or, for that matter, a single core that supports multiple hardware contexts), the selection is relatively straightforward. That is, one of the available cores/thread contexts is selected according to standard processing of the OS scheduler (see, e.g., 54 of FIG. 1). Such standard processing may, for instance, involve selection from among the available cores/thread contexts according a round-robin approach, load balancing policy, or other known selection scheme. Processing then proceeds to block 318.

For a multi-package embodiment (such as, for example, the sample embodiment 270 illustrated in FIG. 2), the selection policy performed at block 316 takes package C-state into account. Such policy may, for example, prefer that an available core/thread context be selected from a package that is in the lowest package C-state. For instance, if two cores are available, but one is in a package that is in Pkg C0 state and the other is in a package that is in Pkg C1 state, the former will be selected at block 316. Thus, at block 316 the method 300 may prefer to select a core/hardware thread context that resides in a package with a lower package C-state. For a core/hardware thread context in a Package C0 state, all components of the package (including and integrated memory and/or U/O control logic on the package) are active and may service the next computing request quickly. Consequently, for the example set forth above, the package in the more power-efficient Package C1 sate may continue to stay in that more-efficient state. For at least one embodiment, then, the selection policy prefers to select, at block 316, a package that is in a non-zero Package C-state, if feasible. From block 316, processing proceeds to block 318.

At block 318, the task is scheduled on the selected core/thread context. Processing then ends at block 320.

Turning to FIG. 4, shown is an embodiment of a method 400 for modifying one or more bits of the system C-state filter 130 when a CPU becomes inactive and also an embodiment of a method 450 for modifying one or more bits of the system C-state filter 130 when an inactive CPU becomes active. For at least one embodiment, embodiments of the methods 400, 450 may be performed by an OSPM module (see, e.g., 52 of FIG. 1). It should not be assumed that the thread unit referenced at block 404 of method 400 is the same thread unit as that referenced at block 454 of method 450 they may be, nut need not be, the same thread unit.

FIG. 4 illustrates that method 400 begins at block 402 and proceeds to block 404. At block 404, it is determined that a thread unit is to enter an idle state. Processing proceeds to block 406. If the idle state to be entered is a deep core C-state (e.g., C3 or higher), processing proceeds to block 408. Otherwise, the idle state to be entered is a shallow state (e.g., core C1 state), and processing proceeds to block 410.

At block 408, the bit in the system C-state filter 130 that corresponds to the thread unit that is entering a deep idle core C-state is modified to reflect an “unavailable” status for the thread unit. In contrast, at block 410 the bit in the system C-state filter 130 that corresponds to the thread unit that is entering a shallow idle core C-state is modified to reflect an “available” status for the thread unit. Processing then ends at block 412.

FIG. 4 illustrates that method 450 begins at block 452. Block 452 is triggered by a break event (e.g., interrupt) to “wake up” a thread unit that is currently in an idle state. From block 452, processing proceeds to block 454. At block 454, the bit in the system C-state filter 130 that corresponds to the waking thread unit is modified to reflect an “available” status for the thread unit. Processing then ends at block 456.

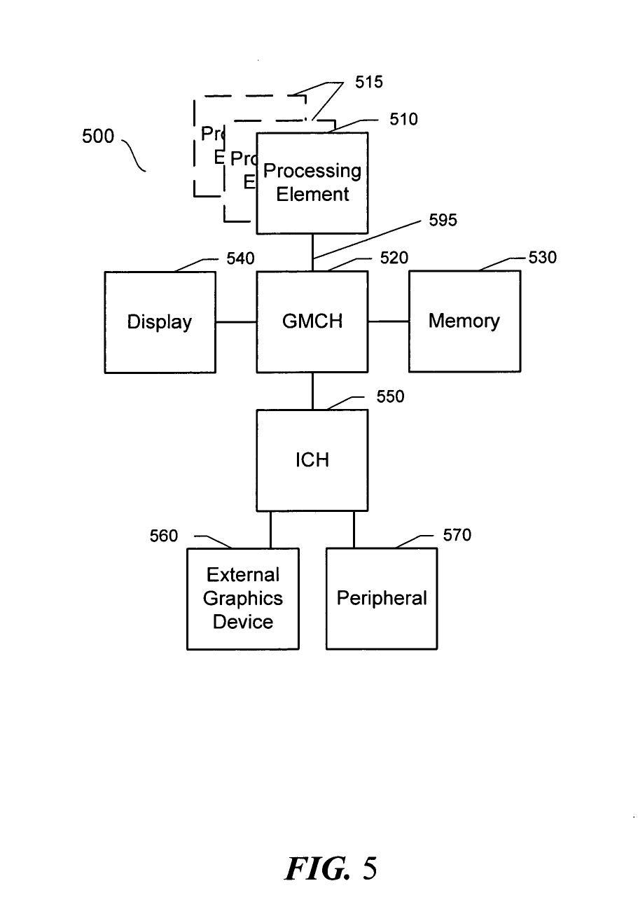

Embodiments may be implemented in many different system types. Referring now to FIG. 5, shown is a block diagram of a system 500 in accordance with one embodiment of the present invention. As shown in FIG. 5, the system 500 may include one or more processing elements 510, 515, which are coupled to graphics memory controller hub (GMCH) 520. The optional nature of additional processing elements 515 is denoted in FIG. 5 with broken lines.

Each processing element may be a single core or may, alternatively, include multiple cores. The processing elements may, optionally, include other on-die elements besides processing cores, such as integrated memory controller and/or integrated I/O control logic. Also, for at least one embodiment, the core(s) of the processing elements may be multithreaded in that that may include more than one hardware thread context per core.

FIG. 5 illustrates that the GMCH 520 may be coupled to a memory 530 that may be, for example, a dynamic random access memory (DRAM). For at least one embodiment, the memory 530 may include instructions or code that comprise an operating system (e.g., 50 of FIG. 1).

The GMCH 520 may be a chipset, or a portion of a chipset. The GMCH 520 may communicate with the processor(s) 510, 515 and control interaction between the processor(s) 510, 515 and memory 530. The GMCH 520 may also act as an accelerated bus interface between the processor(s) 510, 515 and other elements of the system 500. For at least one embodiment, the GMCH 520 communicates with the processor(s) 510, 515 via a multi-drop bus, such as a frontside bus (FSB) 595.

Furthermore, GMCH 520 is coupled to a display 540 (such as a flat panel display). GMCH 520 may include an integrated graphics accelerator. GMCH 520 is further coupled to an input/output (I/O) controller hub (ICH) 550, which may be used to couple various peripheral devices to system 500. Shown for example in the embodiment of FIG. 5 is an external graphics device 560, which may be a discrete graphics device coupled to ICH 550, along with another peripheral device 570.

Alternatively, additional or different processing elements may also be present in the system 500. For example, additional processing element(s) 515 may include additional processors(s) that are the same as processor 510, additional processor(s) that are heterogeneous or asymmetric to processor 510, accelerators (such as, e.g., graphics accelerators or digital signal processing (DSP) units), field programmable gate arrays, or any other processing element. There can be a variety of differences between the physical resources 510, 515 in terms of a spectrum of metrics of merit including architectural, microarchitectural, thermal, power consumption characteristics, and the like. These differences may effectively manifest themselves as asymmetry and heterogeneity amongst the processing elements 510, 515. For at least one embodiment, the various processing elements 510, 515 may reside in the same die package.

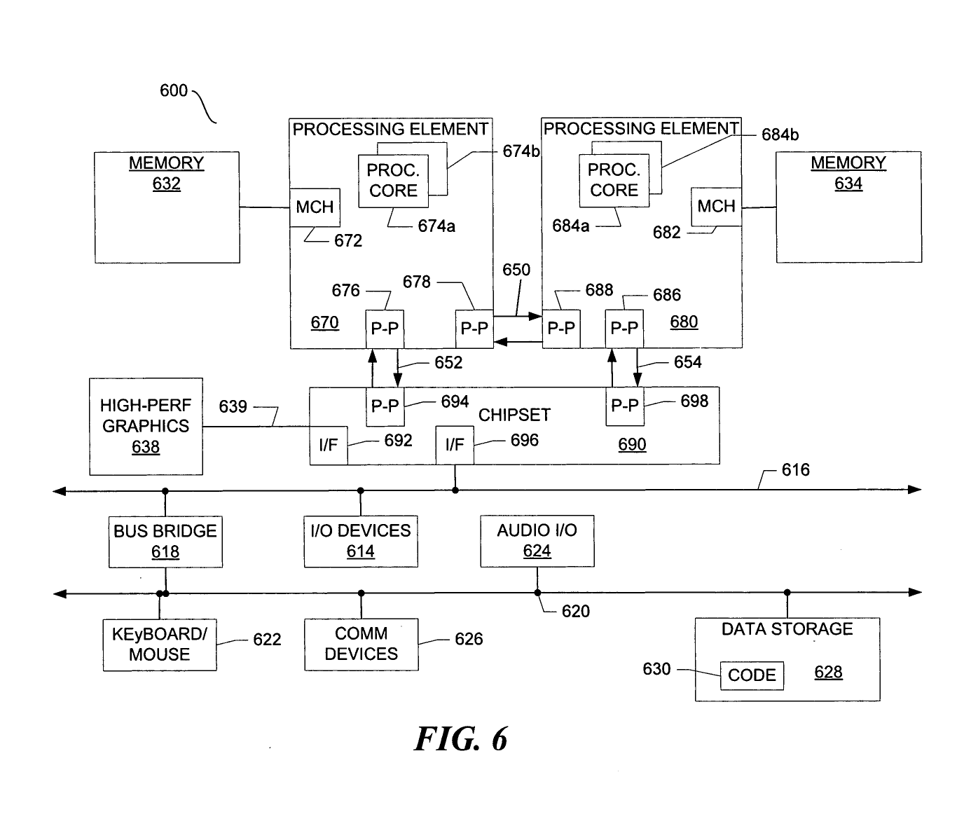

Referring now to FIG. 6, shown is a block diagram of a second system embodiment 600 in accordance with an embodiment of the present invention. As shown in FIG. 6, multiprocessor system 600 is a point-to-point interconnect system, and includes a first processing element 670 and a second processing element 680 coupled via a point-to-point interconnect 650. As shown in FIG. 6, each of processing elements 670 and 680 may be multicore processors, including first and second processor cores (i.e., processor cores 674a and 674b and processor cores 684a and 684b).

Alternatively, one or more of processing elements 670, 680 may be an element other than a processor, such as an accelerator or a field programmable gate array.

While shown with only two processing elements 670, 680, it is to be understood that the scope of the present invention is not so limited. In other embodiments, one or more additional processing elements may be present in a given processor.

First processing element 670 may further include a memory controller hub (MCH) 672 and point-to-point (P-P) interfaces 676 and 678. Similarly, second processing element 680 may include a MCH 682 and P-P interfaces 686 and 688. As shown in FIG. 6, MCH's 672 and 682 couple the processors to respective memories, namely a memory 632 and a memory 634, which may be portions of main memory locally attached to the respective processors.

First processing element 670 and second processing element 680 may be coupled to a chipset 690 via P-P interconnects 676, 686 and 684, respectively. As shown in FIG. 6, chipset 690 includes P-P interfaces 694 and 698. Furthermore, chipset 690 includes an interface 692 to couple chipset 690 with a high performance graphics engine 638. In one embodiment, bus 639 may be used to couple graphics engine 638 to chipset 690. Alternately, a point-to-point interconnect 639 may couple these components.

In turn, chipset 690 may be coupled to a first bus 616 via an interface 696. In one embodiment, first bus 616 may be a Peripheral Component Interconnect (PCI) bus, or a bus such as a PCI Express bus or another third generation I/O interconnect bus, although the scope of the present invention is not so limited.

As shown in FIG. 6, various I/O devices 614 may be coupled to first bus 616, along with a bus bridge 618 which couples first bus 616,to a second bus 620. In one embodiment, second bus 620 may be a low pin count (LPC) bus. Various devices may be coupled to second bus 620 including, for example, a keyboard/mouse 622, communication devices 626 and a data storage unit 628 such as a disk drive or other mass storage device which may include code 630, in one embodiment. The code 630 may include instructions for performing embodiments of one or more of the methods described above. Further, an audio I/O 624 may be coupled to second bus 620. Note that other architectures are possible. For example, instead of the point-to-point architecture of FIG. 6, a system may implement a multi-drop bus or another such architecture.

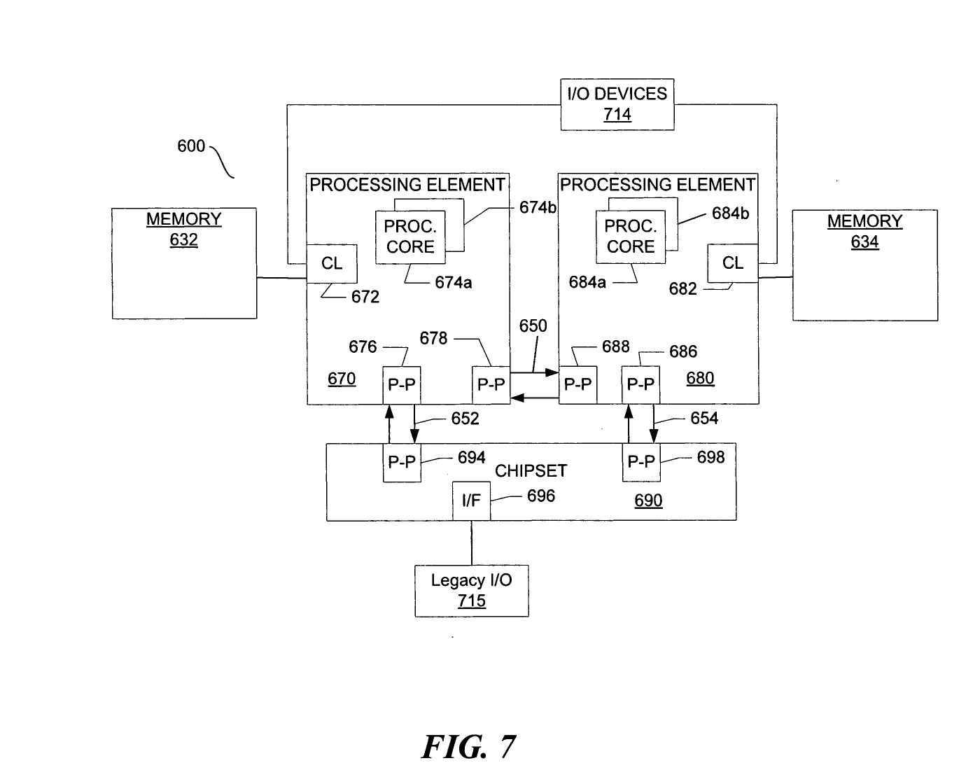

Referring now to FIG. 7, shown is a block diagram of a third system embodiment 700 in accordance with an embodiment of the present invention. Like elements in FIGS. 6 and 7 bear like reference numerals, and certain aspects of FIG. 6 have been omitted from FIG. 7 in order to avoid obscuring other aspects of FIG. 7.

FIG. 7 illustrates that the processing elements 670, 680 may include integrated memory and I/O control logic (“CL”) 672 and 682, respectively. For at least one embodiment, the CL 672, 682 may include memory controller hub logic (MCH) such as that described above in connection with FIGS. 5 and 6. In addition. CL 672, 682 may also include I/O control logic. FIG. 7 illustrates that not only are the memories 632, 634 coupled to the CL 672, 682, but also that I/O devices 714 are also coupled to the control logic 672, 682. Legacy I/O devices 715 are coupled to the chipset 690.

Embodiments of the mechanisms disclosed herein may be implemented in hardware, software, firmware, or a combination of such implementation approaches. Embodiments of the invention may be implemented as computer programs executing on programmable systems comprising at least one processor, a data storage system (including volatile and non-volatile memory and/or storage elements), at least one input device, and at least one output device.

Program code, such as code 630 illustrated in FIG. 6, may be applied to input data to perform the functions described herein and generate output information. For example, program code 630 may include an operating system that is coded to perform embodiments of the methods 300, 400, 450 illustrated in FIGS. 3 and 4. Accordingly, embodiments of the invention also include machine-accessible media containing instructions for performing the operations of the invention or containing design data, such as HDL, which defines structures, circuits, apparatuses, processors and/or system features described herein. Such embodiments may also be referred to as program products.

Such machine-accessible storage media may include, without limitation, tangible arrangements of particles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the mechanisms described herein are not limited in scope to any particular programming language. In any case, the language may be a compiled or interpreted language.

Presented herein are embodiments of methods and systems for task scheduling that takes current power state of the thread unit and/or package into account during operation of a processing system. While particular embodiments of the present invention have been shown and described, it will be obvious to those skilled in the art that numerous changes, variations and modifications can be made without departing from the scope of the appended claims. Accordingly, one of skill in the art will recognize that changes and modifications can be made without departing from the present invention in its broader aspects. The appended claims are to encompass within their scope all such changes, variations, and modifications that fall within the true scope and spirit of the present invention.

What is claimed is:

1. A method comprising:
based on power state information for each of a plurality of thread units, maintaining a system power state filter to indicate which of the thread units are in a low-latency power state; and
utilizing said system power state filter to schedule said task on one of the thread units that is in said low-latency power state.

2. The method of claim 1, wherein said utilizing further comprises:
filtering a task affinity mask, which represents the thread units available for scheduling of said task, to remove any of said thread units that are not in said low-latency power state.

3. The method of claim 2, wherein said low-latency power state further comprises an active state.

4. The method of claim 2, wherein said low-latency power state further comprises a core-clockgated idle state.

5. The method of claim 2, wherein said low-latency power state further comprises a state from the set of states comprising (a core-clockgated idle state and an active state).

6. The method of claim 1, wherein said plurality of thread units reside in the same die package.

7. The method of claim 1, wherein said plurality of thread units reside in a plurality of die packages of a processing system.

8. The method of claim 7, further comprising:
scheduling said task on one of the die packages that is in a low-latency package power state.

9. The method of claim 1, wherein said maintaining further comprises:
updating the system power state filter to indicate an “unavailable” state for any of the thread units entering a high-latency idle state.

10. The method of claim 1, wherein said maintaining further comprises:
updating the system power state filter to indicate an “available” state for any of the thread units that enters an active state.

11. The method of claim 1, wherein said maintaining further comprises:
updating the system power state filter to indicate an “available” state for any of the thread units that enters a low-latency idle state.

12. A system comprising:
a processor including a plurality of thread units;
a power management module to maintain an indicator to reflect whether each of the thread units is in a high-latency power state; and
a scheduler to select one of the thread units for a current task, based on the indicator;
wherein the scheduler is to decline to schedule the task on any of the cores that is in the high-latency power state.

13. The system of claim 12, further comprising:
a memory coupled to the processor.

14. The system of claim 13, wherein the memory is a DRAM.

15. The system of claim 13, wherein the memory is to store code for the scheduler.

16. The system of claim 13, wherein the memory is to store the power management module.

17. The system of claim 12, further comprising one or more additional processors.

18. The system of claim 12, wherein the processors reside on the same die package.

19. The system of claim 12, wherein the scheduler is to select one of the thread units for the current task, based on the indicator and a CPU availability indicator.

20. The system of claim 19, wherein the scheduler is to select one of the cores that is in the high-latency power state, responsive to determining that all cores indicated by the CPU availability indicator are in the high-latency state.

21. An article comprising a machine-accessible medium including instructions that when executed cause a system to:
receive power state information for a plurality of cores of a processor package;
determine which of the cores are available for scheduling of a task;
filter said availability to remove any of the cores that are in a high-latency power state to determine a set of cores having task affinity; and
schedule said task on one of the cores in the set.

22. The article of claim 21, further comprising instructions that when executed enable the system to perform said determining by consulting an operating-system provided default affinity value for the task.

23. The article of claim 21, wherein said power state information further comprises an indication of which of the cores are in the high-latency power state.

24. The article of claim 21, wherein the high-latency power state further comprises a deep core C-state.

25. The article of claim 21, wherein further comprising instructions that when executed enable the system to schedule said task on one of the cores in the high-latency power state, responsive to the set being empty.
